(19) United States
(12) Patent Application Publication
(10) Pub. No.: US 2009/0130504 A1
(43) Pub. Date: May 21, 2009

(54) ELECTROCHEMICAL DISCHARGE CELL

(76) Inventor: Robert Van Burdine, Ardmore, TN (US)

Correspondence Address: CONNOLLY BOVE LODGE & HUTZ LLP, 1875 EYE STREET, N.W., SUITE 1100, WASHINGTON, DC, 20006, US

(21) Appl. No.: 11/943,432

(22) Filed: Nov. 20, 2007

(51) Int. Cl. H01M 12/02

(52) U.S. Cl. 429/15; 429/34

(57) ABSTRACT

An electrochemical cell comprising an electrode and one or more fuel compartments. The fuel compartment includes input and output sidewalls of dimension h and end walls of dimension w. The fuel compartment is arranged between an input flow plate and output flow channel with the input flow plate adjacent to the input side wall and the output flow channel adjacent to the output side wall of the fuel compartment. The input flow plate comprises a porous membrane or a plurality of openings through which electrolyte can flow into the fuel compartment from an electrolyte source. The input flow plate directs the flow of the electrolyte through the fuel compartment in a direction essentially parallel to dimension w and into the output flow channel.

### TECHNICAL FIELD

This application relates to an electrochemical cell, and to the use of the cell in the form of a battery for electric-powered vehicles, electric power grid energy storage and delivery systems, renewable energy storage and delivery systems, and stand-alone electric generation units.

### BACKGROUND

The ability to provide continuous electrical power at high current drain rates from a conventional battery over long periods of time is problematic due to the consumption of the fuel components in the battery as well as the limited volume of electrochemical fuel that can be contained within the battery. Also, the accumulation of reaction products inside the battery, e.g., in the form of sludge deposits against the surface of the conducting electrodes, reduces the overall efficiency of the electrochemical processes and thereby limits the discharge cycle. Consequently, many such batteries can only power a vehicle for about one hundred miles before it is necessary to connect to the power grid or another source of electrical power to recharge the battery. Also, the extensive recharge time makes such a vehicle highly impractical for any excursion beyond its single charge capacity. The ability to adequately address many of these issues has hampered the development of electric-powered vehicles. The use of conventional batteries is further hampered by the eventual requirement for their disposal. In the case of the electric power grid industry, it is desirable to be able to store electrical power during times of limited usage, sometimes referred to as ‘off-peak’, and deliver that electrical power back to the electric power grid during ‘on-peak’. Standard batteries have a limited cycle, or number of recharges, due to the disarrangement of their electroactive components. This means that the elctroactive components undergo a chemical and physical change during the discharge process, and during the charging process these chemical reactions are reversed, but during the process the electroactive materials are depleted in some areas and concentrated in other areas due to small inconsistencies within the battery cell. This process causes a structural deficiency that eventually renders the battery cell inoperative and requires that it be disposed of and replaced. Typical battery materials are hazardous and it is usually undesirable to dispose of them in an economically sound manner. Conventional batteries have similar issues in the renewable energy arena again due to their requirement for replacement. It is often desirable to decouple renewable energy sources such as wind turbines for the electric power grid due to excessive inrush currents and large voltage swings that are typical of such devices and are disruptive to the stability of an electric power grid. Conventional storage batteries do not offer isolation as their charge and discharge components are connected simultaneously to the renewable energy source and the electric power grid.

Attempts to develop battery powered vehicles have also been hampered by the relatively low energy densities achievable in conventional batteries, and there have been many attempts to circumvent this problem. One such attempt involves the mechanical replacement of the electrochemical fuel components in order to “recharge” the battery. This is in contrast to the “golf cart” process of directly recharging the battery with an external electrical source. One such method includes the replacement of pouches or cartridges containing reprocessed electrochemical fuel components. The cartridges can then be reprocessed at an external facility. However, this method requires some physical modification of the battery cell to accomplish the refueling function. Also, this method does not adequately address the problem associated with the accumulation of reaction products that are produced in the cell during discharge. Energy density can be improved by the use of a lightweight electrode such as the air electrode, but these devices are short lived and require periodic replacement. Also, such devices are often not capable of delivering the electrical energy at a high rate as is typically the requirement in a vehicular system. Electric Power Grid Storage and delivery systems as well as renewable energy storage and delivery systems both require a high rate of energy delivery. In this manner the short term demands for power can be more readily met without the need for an extensive number of battery cells.

The technological possibility to a battery for transportation that has characteristics similar to the fossil fueled engine in terms of easy refueling and a sufficient and practical discharge cycle to operate at distances several hundred miles between refueling is very desirable. It is also desirable to provide an electric generation system that includes a battery, which would produce electrical power independent of on-board or locally expended fossil fuels as in the case of the present hybrid electric battery vehicle where the fossil fueled engine drives a generator that continuously recharges the battery in a “power leveling” manner. It is also desirable to be able to store electrical power as chemical energy and deliver that electrical power on demand. In the case of the electric power grid, it is desirable to store energy during off-peak demand times when excess energy is available from time to time on the electric power grid. This storage of energy is desirable to be obtained over many hours or days of operation. However, when the electric power is in demand during the on-peak periods of electrical surge, it is desirable to discharge this energy into the electric power grid at a high rate of speed. This is also true in the case of renewable energy. The sun only shines and the wind only blows when it does. Photocells and wind turbines produce energy when there is natural energy to collect, not necessarily during the demand times for electrical power. It is therefore desirable to store the electrical power produced as chemical energy over the entire collection period, and deliver that energy to the electric power grid during times of peak demand.

Metal/air batteries, such as zinc/air batteries, have long held promise for application in stationary and mobile power sources because of their high energy density, low cost, and use of benign materials. Air-metal cells are well known in the art and generally comprise a consumable metal anode, a catalytic non-consumable oxygen consuming cathode and a suitable electrolyte. Some of these primary fuel cells are multi-cell batteries with replaceable anodes. Air-metal batteries such as zinc-oxygen cells have been used as a power source for electric vehicles because they provide high energy density relative to other cell chemistries. Zinc-oxygen cells can also be recharged by mechanically replacing the zinc electrode or by replacing the liquid electrolyte which contains zinc particles. Air-metal cells exhibit a relatively high energy density as the air electrode is very lightweight and therefore offers a distinct and immediate weight savings to a vehicle. The air electrode is prone to a failure condition called flooding, and for this reason is often short lived and must be replaced and disposed of, or re-manufactured, from time to time. Also, air electrodes to date have limitations as to the amount of oxygen they can move from the air into the chemical reaction of the battery cell, and this imposes a limit on the rate at which the battery cell can discharge its electrical power. This limitation imposes either a critical power rate limit on the design, or mandates that additional air-metal battery cells be applied to supply the desired currents, therefore losing the weight advantage. In the case of the electric power grid and renewable energy storage and delivery systems, the power discharge rate requirement is very high, and would require a prohibitive cross sectional area of the air electrode to accomplish such discharge rates.

Zinc/air batteries include a zinc-based electrochemical fuel, an electrolyte solution (usually alkaline NaOH or KOH) and a gas-diffusion electrode. The gas diffusion electrode is typically a porous structure through which atmospheric oxygen diffuses to an electrolyte-wetted and catalyzed surface where oxygen is reduced to hydroxide. Such gas diffusion electrodes can be made of porous carbon particles bonded to a supporting and conducting positive screen, catalyzed with noble metals or organo-metallic compounds, and wet-proofed on the air side with fluorocarbon materials. The zinc fuel and electrolyte could be added periodically in a manner analogous to the refueling of an automobile. At the same time, the spent electrolyte (containing zincate and zinc oxide) produced during a previous discharge could be removed from the vehicle. The zinc metal and electrolyte can then be regenerated by electrolysis and/or various chemical or thermal reduction techniques at a fixed industrial or service site. Thus, a fixed quantity of zinc would be recycled indefinitely between recovery equipment and the vehicle, and the vehicle could be refueled rapidly at a service station for indefinite range extension. Such an application is particularly attractive in fixed route vehicles such as vans and buses, which may be refueled periodically at a single site on the route. The air electrode can also be remanufactured and otherwise refurbished from time to time. Low cost and high energy adsorption and discharge are desirable for the electric power grid buffer and renewable energy electric power storage and delivery industries. System weight is not an issue in such systems.

Developers at LUZ, Inc. have disclosed several versions of zinc particle anodes configured as static beds. U.S. Pat. No. 5,145,752 discloses the use of very fine zinc particles (5-500 microns) in an alkaline electrolyte with a gas diffusion electrode. U.S. Pat. No. 5,185,218 further describes the use of a particulate zinc anode with a cathode depolarized by an oxygen-bearing liquid such as a fluorocarbon oil. U.S. Pat. No. 5,208,526 describes the use of a static bed anode which surrounds an air cathode unit. In the practical vehicle battery only 80% of the zinc in the cell is available for use, and the cassette containing the zinc must be refurbished at an industrial site in a process which recovers unconsumed zinc, zinc oxide, zincate and electrolyte. If the bed clogs with a paste of unreacted zinc, zinc oxide, zincate, and electrolyte, then high velocity electrolyte jets are used to dislodge and remove caked material from the cell in order to recharge the cell mechanically.

U.S. Pat. No. 5,434,020 attempts to address the accumulation of reaction products in the cell by controlling the flow of electrolyte through a fuel compartment that is continually constricted or tapered along the flow axis of the cell. The electrolyte flows from a constricted zone to a more open zone containing a quasi-stationary bed of electrochemically active particles. The tapered cell compartment is said to provide the electrolyte with sufficient velocity to fluidize the bed, while the lower velocities in the bulk of the cell compartment prevent loss of particles from the cell. However, such a cell design tends to decrease the fuel density of the electrochemical fuel components and increase the overall size requirement of the cell.

### SUMMARY

The disclosure is directed to an electrochemical cell comprising an electrode and a fuel compartment. The electrode may also be an opposing fuel compartment. The fuel compartment includes input and output sidewalls of dimension h and end walls of dimension w. The fuel compartment is arranged between an input flow plate and output flow channel with the input flow plate adjacent to the input side wall and the output flow channel adjacent to the output side wall of the fuel compartment. The input flow plate comprises a porous membrane or a plurality of openings through which electrolyte can flow into the fuel compartment from an electrolyte source. The input flow plate directs the flow of the electrolyte through the fuel compartment in a direction essentially parallel to dimension w and into the output flow channel.

The disclosure is also directed to an electrochemical cell comprising a centrally arranged electrode and at least two fuel compartments with output and input sidewalls of dimension h and end walls of dimension w. Each of the fuel compartments are arranged between an input flow plate and output flow channel, the input flow plate adjacent to the input side wall and the output flow channel adjacent to the output side wall of the fuel compartment. At least two fuel compartments are symmetrically arranged on either side of the electrode. The input flow plate comprises a porous membrane or a plurality of openings through which electrolyte can flow into the fuel compartment from an electrolyte source. The input flow plate directs the flow of the electrolyte through the fuel compartment in a direction essentially parallel to dimension w and into the output flow channel.

The present disclosure provides for the use of an air-metal cell and also a metal-metal cell which, while heavier, provides for the maximum discharge rate to deliver power. This device has clear advantages for use in vehicles when lighter metals such as magnesium for the negative electrode and iodate for the positive electrode are used.

A battery according to the exemplary embodiments can have applications as an electric power grid energy storage and discharge device, a renewable energy power storage and discharge device, and a stand-alone electric generating unit, e.g., at a remote and/or environmentally hostile location, to reliably generate electrical power on demand for an extended period of time.

### BRIEF DESCRIPTION OF THE DRAWINGS

These and other features of the present disclosure will become apparent upon consideration of the following detailed description of the disclosure when read in conjunction with the drawings, in which:

FIG. 1 is a schematic cross-sectional representation of one embodiment of an electrochemical cell;

FIG. 2 is a schematic representation of another embodiment of an electrochemical cell;

FIGS. 3(a) to 3(d) are schematic cross-sectional representations of various embodiments of an input flow plate;

FIGS. 4(a), 4(b) and 4(c) are schematic representations of the flow of electrolyte and electrochemical reaction products through three screens in two embodiments of an electrochemical cell;

FIGS. 5(a), 5(b), 5(c) and 5(d) are schematic representations of electrolyte flow in various embodiments of an electrochemical cell;

FIG. 6 is a time function representing the opening and closing of a pulse valve to allow electrolyte to flow to the electrochemical cell;

FIG. 7 is a schematic representation of the electrolyte flow through a parallel arrangement of electrochemical cells in a battery;

FIG. 8 is a schematic representation of the electrolyte flow indicating all of the cell valves in the closed position except one; and

FIG. 9 is a schematic representation of the electrolyte flow similar to the arrangement shown in FIG. 8 with the exception that the pulse valve is closed.

### DETAILED DESCRIPTION OF PREFERRED EMBODIMENTS

The disclosure is directed to an electrochemical cell comprising an electrode, and a fuel compartment with input and output sidewalls of dimension h and end walls of dimension w. The fuel compartment is arranged between an input flow plate and output flow channel. The input flow plate is positioned adjacent to the input side wall and the output flow channel is positioned adjacent to the output side wall of the fuel compartment. The input flow plate comprises a porous membrane or a plurality of openings through which electrolyte can flow into the fuel compartment from an electrolyte source. The porous membrane or the openings extend substantially along a surface of the input flow plate adjacent to the input side wall of the fuel compartment. The input flow plate facilitates the flow of the electrolyte from the electrolyte source through the fuel compartment in a direction essentially parallel to dimension w and toward the output flow channel.

The metal-metal cell of the present disclosure might be, as an example, a combination of zinc in the negative electrode, and iron oxide, in the form of FeOOH in the positive electrode. This provides for a heavy but low cost electrochemical fuel material that is readily charged and discharged in the continuous cycle as per the present disclosure. Typical materials that may be utilized in the present disclosure include, but are not limited to, the following table of materials in all possible combinations.

| Anode Materials | Cathode Materials |
|---|---|
| Most Negative | Most Positive |
| Lithium | Ferrate |
| Magnesium | Iron Oxide |
| Aluminum | Cuprous Oxide |
| Zinc | Iodate |
| Chromium | Cupric Oxide |
| Iron | Mercuric Oxide |
| Nickel | Cobaltic Oxide |
| Tin | Manganese Dioxide |
| Lead | Lead Dioxide |
| Hydrogen | Silver Oxide |
| Copper | Oxygen |
| Silver | Nickel Oxyhydroxide |
| Palladium | Nickel Dioxide |
| Mercury | Silver Peroxide |
| Platinum | Permanganate |
| Gold | Bromate |
| Least Negative | Least Positive |

The term “output and input side walls” as related to the fuel compartment refers to actual structural side walls of the fuel compartment as well as regions of the fuel compartment that are in direct contact with an adjacent component of the electrochemical cell. For example, an output side wall of the fuel compartment can be defined by a structural wall of the adjacent output flow channel. Likewise, an input side wall of the fuel compartment can be defined by a structural wall of the adjacent input flow plate. Accordingly, the term “output and input side walls” is used to designate in space a physical boundary between the fuel compartment and the adjacent components of the electrochemical cell.

The electrochemical cell can also include one or more screens that extend substantially between and along the output side wall of the fuel compartment and the output flow channel. The term “screen” refers to a porous substrate with a plurality of openings that allows particles with a diameter smaller than the average pore (opening) size of the substrate, or a fluid such as electrolyte, to readily pass through the substrate whereas relatively large particles cannot pass through the substrate. It is to be understood that one of ordinary skill would recognize that the term screen used in this context includes a porous cloth or a porous membrane.

The one or more screens used in the electrochemical cell can be electrically conductive or electrically non-conductive. In a more preferred embodiment, at least one of the one or more screens is electrically conductive. The term “electrically conductive” in this disclosure refers to a material with an electrical conductivity of at least that of carbon (0.727 (mohm cm)⁻¹). Exemplary conductive materials comprise metals, plastics, cloths and inorganic or organic materials.

The input flow plate directs the input of electrolyte from an electrolyte source to the electrochemical fuel compartment. The input flow plate is positioned adjacent to the input side wall of the fuel compartment, and comprises a porous membrane or a plurality of openings through which electrolyte can flow into the fuel compartment from an electrolyte source. The porous membrane or the openings extend substantially along a surface of the input flow plate adjacent to the input side wall of the fuel compartment. The input flow plate facilitates the flow of the electrolyte from the electrolyte source through the fuel compartment in a direction essentially parallel to dimension w and toward the output flow channel.

As with the one or more screens that extend substantially between and along the output side wall of the fuel compartment, the input flow plate of the electrochemical cell can be electrically conductive or electrically non-conductive. In one embodiment, the input flow plate comprises a screen. In another embodiment, the input flow plate can be fabricated from metal sheet.

In one embodiment, the input flow plate of the electrochemical cell comprises openings and flaps that extend in the direction of the fuel compartment as electrolyte flows through the openings and into the fuel compartment. One function of the flaps is to essentially block the openings if there is insubstantial flow of electrolyte through the openings. For example, the input flow plate can comprise a stainless steel sheet with an array of openings with the rows or columns of openings covered by a flap that can also be made from a stainless sheet. The flap is welded along one long edge across the row or down the column. Passage of electrolyte through the openings causes the flaps to move in the direction of the fuel compartment.

The output flow channel directs the electrolyte that has passed through the electrochemical fuel compartment out of the cell. The electrolyte that enters the output flow channel also contains a significant amount of electrochemical reaction products that are produced in the fuel compartment of the cell. Both the input flow plate and the output flow channel of the electrochemical cell are designed to direct the flow of the electrolyte across the fuel compartment in a direction essentially parallel to dimension w of the fuel compartment. As a result, the electrolyte and the reaction products flow or move along relatively short distances through the cell and into the output flow channel. The flow design of the electrochemical cell minimizes the build-up or the residence time of the reaction products in the fuel compartment. For example, if the electrochemical fuel comprises active zinc, the resulting zinc oxide and zinc hydroxide are directed to the output flow channel with the electrolyte and out of the cell.

In one embodiment, the output flow channel is partitioned with flow channel members. Also, like the screens and the input flow plate, the flow channel members can be electrically conductive. The flow channel members can also be configured to facilitate the insertion and removal of the electrode from the electrochemical cell.

A discharge fluid containing electrolyte, the electrochemical reaction products and small amounts of unreacted zinc particles exit the electrochemical cell from the output flow channel. The discharge fluid can then be treated to separate the reaction products and unreacted zinc particles from the electrolyte. The electrolyte obtained from the treated discharge fluid can then be returned to the electrochemical cell, i.e., the input flow plate. The discharge fluid can be treated by any suitable chemical treatment and/or physical separation method.

The electrochemical cell can be used in conjunction with a storage tank for fresh electrolyte, which is supplied to the cell, and a storage tank to contain the discharge fluid. The discharge fluid can then be treated at an external facility. Alternatively, the discharge fluid, or at least a portion of the discharge fluid, can be treated on-site, e.g., on board the electric powered vehicle. The treated electrolyte is then returned to the electrolyte storage tank or directly to the input flow channel of the cell.

Any suitable electrode can be used in the electrochemical cell. The type of electrode will depend on the selection of the other components of the cell, e.g., the fuel component and electrolyte. In one embodiment, an oxygen diffusion cathode known in the art, e.g., a catalyst-containing air diffusion cathode, can be used in the electrochemical cell. One such air cathode will include catalytic sites, e.g., platinum supported on carbon or graphite, for oxygen reduction in the discharge mode. To reduce corrosion at higher charge rates, graphite may be used as the catalyst support.

Bifunctional oxygen diffusion cathodes can also be used, for example, a plated platinum screen on the electrolyte side to provide a catalytic site for oxygen evolution. The diffusion cathode is gas permeable to allow oxygen to reach the catalytic reaction sites but is liquid impermeable to retain the electrolyte. The bifunctional diffusion cathode is of particular advantage in a centrally arranged electrochemical cell. The central position of the cathode, and particularly, if the cathode is cylindrical in shape, and the concentric ion conducting separator surrounding and in structural contact with it provide a structure which can withstand higher pressure differentials between the gas pressure within the gas diffusion cathode and the liquid electrolyte surrounding the separator. Higher pressure differentials permit more complete flushing of reaction products from reaction sites within the cathode.

An air-cathode uses oxygen found in the atmosphere as a consumable material, and thus, offers attractive possibilities for alternate energy generation. One such air cathode that can be used in the electrochemical cell is described in U.S. Pat. No. 6,127,061, the entire disclosure of which is incorporated by reference into this application.

The catalytic air-cathode includes an outer layer that it is highly permeable to air or oxygen, yet water impermeable. The outer layer also offers capacitance for storage of electrons. Laminated to the outer layer is an electron conductor and a current collector or conductive structure. The current collector can be any suitable highly conductive material that has sufficient passageways to allow the air or oxygen flow coming from the outer layer to pass through the conducting structure. Bonded to the conductive structure is a catalytic layer. The catalytic layer is exposed to the free-air or oxygen flow through the electrically conductive structure on one side and electrolyte at its other side (inner-surface side of cathode). The catalytic layer provides locations for the catalytic reactions necessary to generate the electric current.

The electrically conductive structure can be made of any suitable material which can be fabricated in a sheet form and provide high electrical conductivity without interfering in the electrochemical reactions. Copper, nickel mesh, or electroplated nickel on copper and preferably having a mesh size of 20 to 40, has been found to be particularly suitable for use as the electrically conductive layer. Other suitable electrically conductive layers may be brass or copper honeycomb cores or even a row of individual conductive metal wires running from the interior of the cathode to an exterior terminal.

A pump can be used to increase the pressure of the air or oxygen flow to the cathode. Of course, any kind of pump, fan, or other technique for increasing the air or oxygen pressure to the air cathode can be used including a cylinder of compressed air or oxygen as indicated by cylinder.

The anode material is typically particles of electrochemically active metals, compounds, or composites. Examples of electrochemically active particles include zinc particles, aluminum spheres, iron, cadmium or lead particles in an alkaline electrolyte, and calcium particles in mixed alkaline and halide solutions.

One of the more preferred electrochemically active metals are porous zinc particles, which are present in an amount of about 10% to 70% by weight relative to the weight of the electrolyte in the fuel compartment. The porous zinc will preferably have a density which is 5 to 20% of the density of non-porous zinc, e.g. it may have a density within the range of 0.3 to 1.4 g/cm³, preferably 0.3 to 1.1 g/cm³, and a surface area within the range 0.5 to 6.0 m²/g, preferably 0.75 to 5.0 m²/g.

The electrolyte is provided to the electrochemical cell from an electrolyte source. In some cases, the electrolyte is provided to the cell at a desired pressure. The electrolyte passes through the input flow plate, travels across the fuel compartment in a direction essentially parallel to dimension w of the fuel compartment, toward the output flow channel and eventually out of the cell. Suitable flow rates for the electrolyte through the cell are in the order of about 0.01 to 100 m³/min. Optimal flow rates can be determined by one of ordinary skill in the art.

The electrolyte can be aqueous, e.g., alkaline, saline or acid, or even non-aqueous. The electrolyte must be chosen in relation to the anode material of the cell so that the electrochemical reaction will proceed with a minimum of parasitic reactions. The use of a saline (salt) electrolyte is important, especially to avoid carbonation by the atmosphere's carbon dioxide. However, an alkaline electrolyte is one which is generally the most advantageous to use. In fact, the oxidation of metals such as zinc can be conducted in an alkaline environment with rapid agitation, and zinc is oxidized with current densities which are very high. The alkaline electrolyte is preferably a solution of sodium hydroxide or potassium hydroxide, preferably the latter or a mixture of both. Its concentration can range from 0.01 N to 13.5 N, but it is preferably between 7 and 13.5 N.

All or a portion of the electrolyte passing through the cell can be regenerated. The regeneration of the electrolyte can be accomplished be any suitable means for regeneration of the electrolyte such as removal of the reaction products, e.g., zincate particles, from the electrolyte. The electrolyte is provided to the cell with an electrolyte input system.

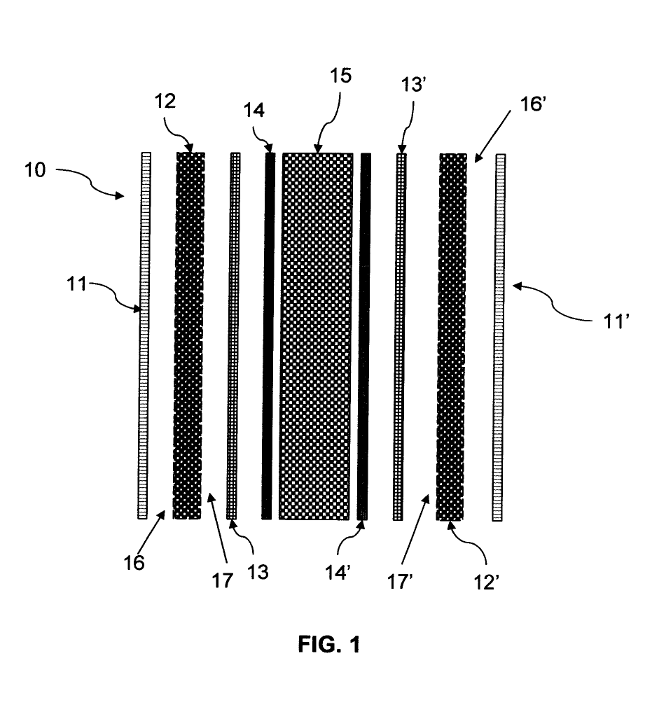

The electrochemical cell(s) can be arranged in any number of spatial configurations including a cylindrical configuration or a block configuration. For example, FIG. 1 is a schematic cross-sectional representation of an electrochemical cell 10 in which the electrode 15 is centrally positioned and the components of the cell are in a block configuration. To better show the arrangement of each component in the electrochemical cell, the cell is depicted with each component separated in space. In actuality, the cell components are arranged in a continuous fashion in the cell. As shown, two output flow channels 14 and 14′ are provided on either side of the centrally positioned electrode 15. Again, if the electrode 15 is an air cathode, the air cathode will be designed to allow air or some other oxygen containing gas to flow through the cathode. The optional one or more screens 13 and 13′, fuel compartments 12 and 12′ and the two input flow plates 11 and 11′ are arranged about the electrode 15. The input side walls 16 and 16′ and output side walls 17 and 17′ for each of the fuel compartments are also depicted.

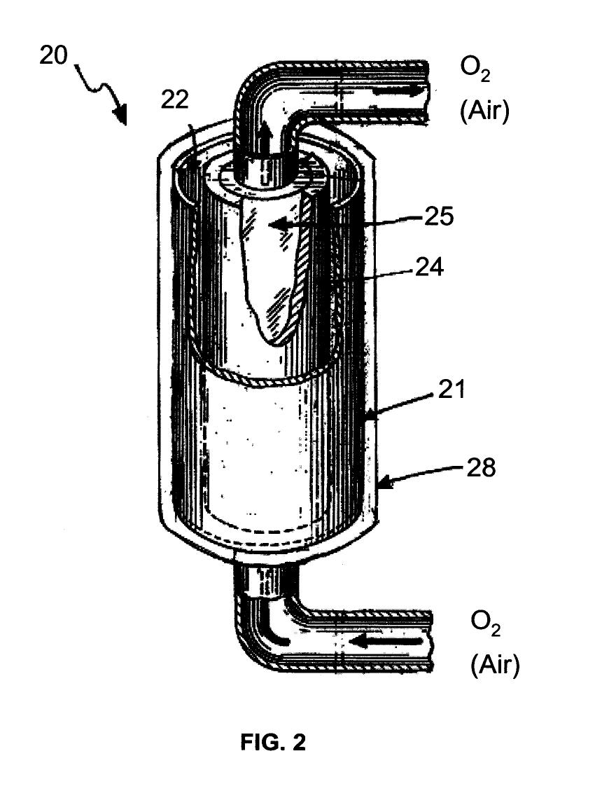

FIG. 2 is a schematic representation of a cylindrical arrangement for an electrochemical cell. As shown, the electrochemical cell 20 comprises a cylindrical electrode 25 that is centrally arranged in the cell. If the electrode 25 is an air cathode, the cathode will be designed to allow air or some other oxygen containing gas to flow through the cathode. The output flow channel 24 would be arranged about the cylindrical electrode followed by the optional one or more screens (not shown) and the fuel compartment 22. The input flow plate 21 would then be arranged about the perimeter of the fuel compartment 22. The electrolyte is added to the cell via a compartment between the input flow plate 21 and external housing 28. The electrolyte is provided to the input flow plates from an electrolyte source (not shown).

The input flow plates shown in FIGS. 1 and 2 can be a porous membrane or a substrate with a plurality of openings through which electrolyte can flow into the fuel compartments from the electrolyte source. The porous membrane or the openings extend substantially along a surface of the input flow plates adjacent to the input side wall of the fuel compartments, and thereby provide for the flow of the electrolyte through the fuel compartments in a direction essentially parallel to dimension w and toward the output flow channels proximate to the electrode.

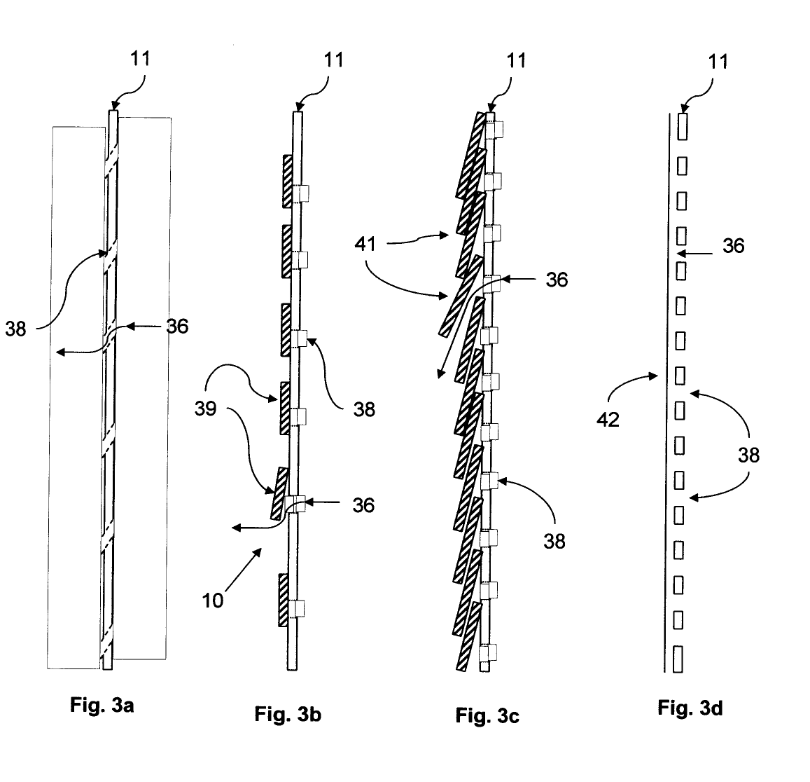

FIGS. 3(a) to 3(d) are representative cross-sectional views of possible embodiments for the input flow plate 11. One function of the flow plate is to direct the flow of electrolyte 36 through the flow plate and into the fuel compartment, which will contain the electrochemical fuel. As shown in FIG. 3(a), flow plate 11 includes openings 38 through which the electrolyte 36 can flow into the fuel compartment. The openings 38 can include holes, slots or other geometries. The openings 38 also provide for the electrolyte to flow into the fuel compartment at relatively high velocity, which facilitates the flow of the electrolyte across the fuel compartment in a direction essentially parallel to dimension w and into the output flow channel. The openings 38 are sufficiently small to minimize or preclude the passage of the electrochemical fuel, yet allow electrolyte 36 to flow into the fuel compartment.

In another embodiment, the flow plate 11 of FIG. 3(b) includes flaps 39 to minimize or preclude the passage of electrochemical fuel through the openings 38, yet allow electrolyte 36 to pass through the flow plate 11. As electrolyte 36 flows through an opening 38, flap 39 is deflected outward toward the fuel compartment allowing the passage of electrolyte 36 into the compartment. When electrolyte is not flowing, the flap 39 essentially remains in contact with flow plate 11 effectively blocking the opening 38. The outward motion of flaps 39 can provide sufficient vibration or motion to the electrochemical fuel, which helps to minimize the accumulation of electrochemical reaction products, e.g., Zn(OH)₂, proximate to the flow plate 11. The movement imparted by flaps 39 also can help compact and settle the electrochemical fuel in the cell, thus providing conditions more suitable for electrical conduction.

In yet another embodiment, flow plate 11 includes overlapping plates 41. The overlapping plate 41 is attached to flow plate 11 such that the flow of electrolyte 36 through opening 38 causes the outward deflection of the overlapping plates forming a flow gap. The arrangement of overlapping plates 41 minimizes or precludes the electrochemical fuel from passing through openings 38, yet the plates 41 provide for the electrolyte to flow through the openings. Again, when the electrolyte is not flowing the plates 41 effectively block openings 38. Also, the outward motion of plates 41 can provide sufficient vibration or motion to the electrochemical fuel, which helps to minimize the accumulation of electrochemical reaction products, e.g., Zn(OH)₂, proximate to the flow plate 11. The movement imparted by plates 41 also can help compact and settle the electrochemical fuel in the cell, thus providing conditions more suitable for electrical conduction.

In yet another embodiment, flow plate 11 includes an overlaying membrane 42. Membrane 42 can be a woven or non woven screen or cloth. The membrane 42 can also be electrically conductive or electrically non-conductive. A function of the membrane 42 is to minimize or preclude the movement of electrochemical fuel into openings 38, yet allow electrolyte 36 to pass through the flow plate and into the fuel compartment.

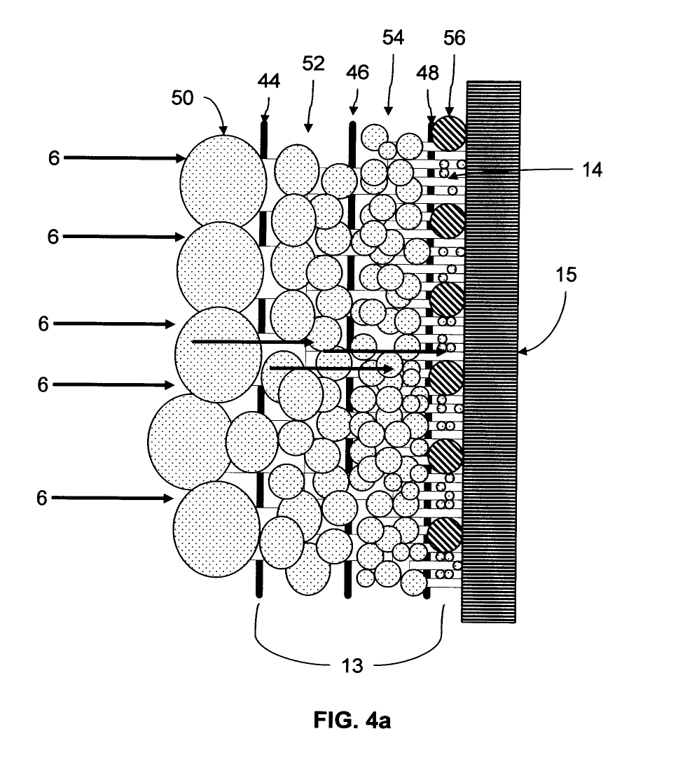

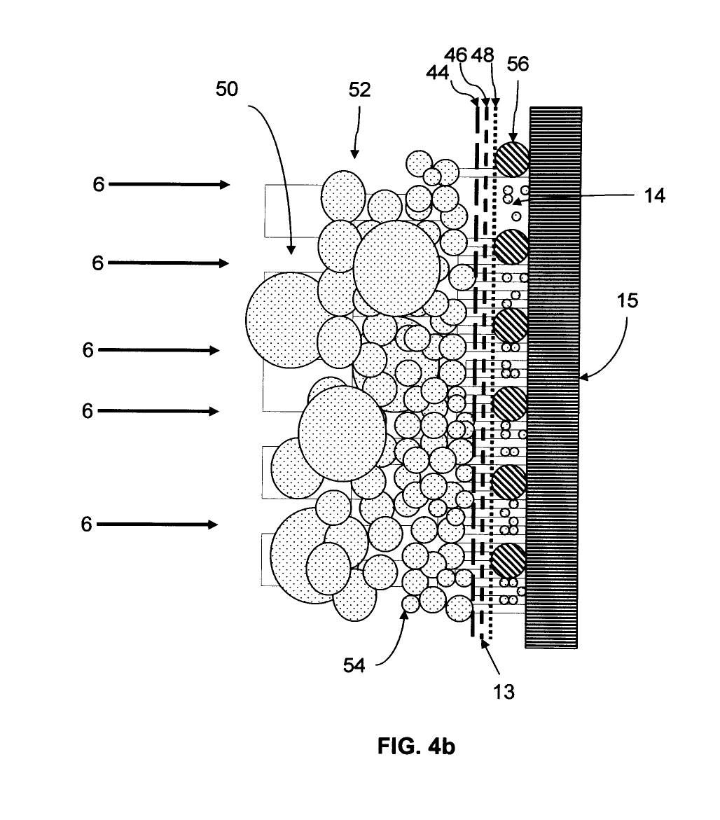

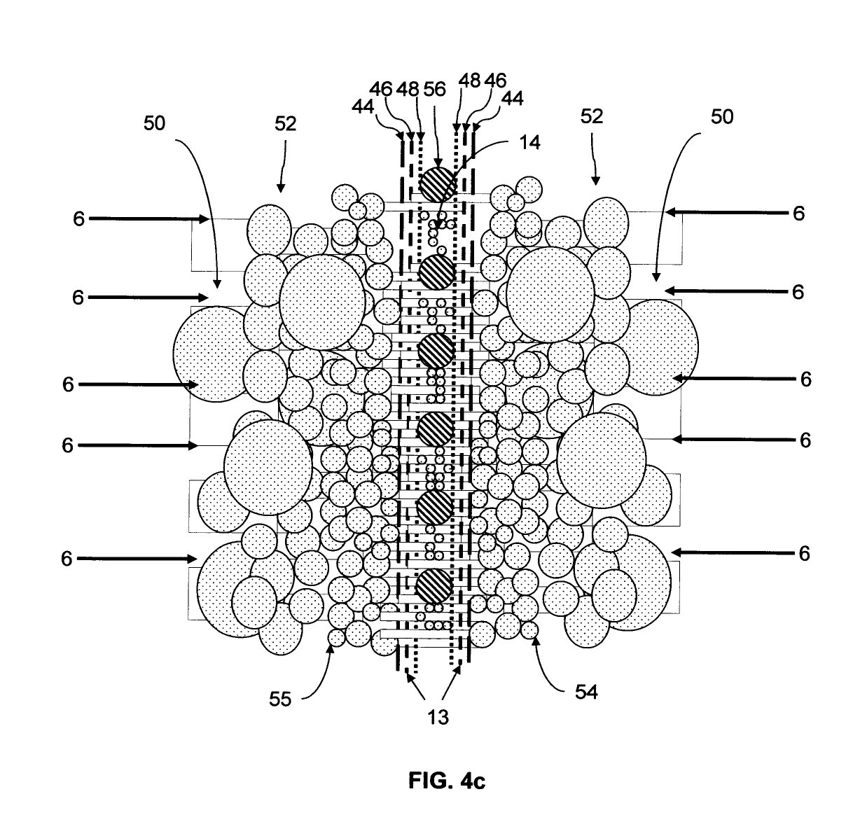

FIG. 4 is a schematic representation of an electrically conductive screen 13 that includes three electrically conductive screens 44, 46 and 48 of different pore size. As shown, the pore size of each screen decreases in the direction of the output flow channel 14. The use of the three screens 44, 46 and 48 helps to maintain the fuel particles 50, 52 and 54 in near constant contact with an electrical conductor, that is, the respective conductive screen, as the fuel particles become ever smaller in size. As a result, the three electrically conductive screens increase the probability of electron capture. Also, because the electrochemical reaction products are of relatively small particle size (as shown by the small particles in flow channel 14) the reaction products can readily pass through each of the screens 44, 46 and 48 and eventually into the output flow channel 14 and expelled from the cell. The directional flow of electrolyte across the fuel compartment and toward the output flow channel facilitates the removal of the reaction products from the electrochemical cell.

As depicted in FIG. 4(a), as the fuel particles 50, 52 and 54 react with the electrolyte the fuel particles become smaller and smaller in size and pass through each of the successive screens 44, 46 and 48. For example, the pore size of screen 44 is selected to preclude the passage of fuel particles 50 having an initial average particle size. As the electrochemical reaction proceeds, fuel particles 50 decrease in size until they are capable of passing through screen 44. As the fuel particles 52 continue to react with electrolyte they will further decrease in particle size and eventually pass through screen 46. During this reaction process the reaction products that form are carried through the screens and into the output flow channels.

In one embodiment, at least one or more of screens 44, 46 and 48 are electrically conductive. Preferably, each of the screens 44, 46 and 48 are electrically conductive. Each electrically conductive screen is capable of capturing electrons as the fuel particles and electrolyte is consumed in each of the respective regions provided by screens 44, 46 and 48.

In another embodiment, screen 13 can comprise screens with no intervening space as shown in FIG. 4(b). As the fuel particles react with the electrolyte an electrical current is produced, and the fuel particles pass through each of the successive screens until the reaction products and any remaining fuel particles flow into the output flow channel 14 and out of the cell.

In another embodiment, screen 13 can comprise dual and opposing screens with no intervening space as shown in FIG. 4(c). As the fuel particles react with the electrolyte an electrical current is produced, and the fuel particles pass through each of the successive screens until the reaction products and any remaining fuel particles flow into the output flow channel 14 and out of the cell. This embodiment provides for the use of two opposing metal fuel electrodes, 54 and 55 of opposing polarities.

Output flow channel 14 is defined by the region between the screen 13 and electrode 15. As shown, the output flow channel 14 can further include flow standoffs 56. In one embodiment, the flow standoffs 56 are electrically conductive and assist in the capture of electrical current and the reduction of overall cell resistance. Flow standoffs 56 can be in the shape of rods or partial rods of varying geometries. Also, it is preferred that the flow standoffs 56 be smooth and provide a ready and unrestricted slide area for the insertion and removal of electrode 15 in the case where electrode 15 is replaceable.

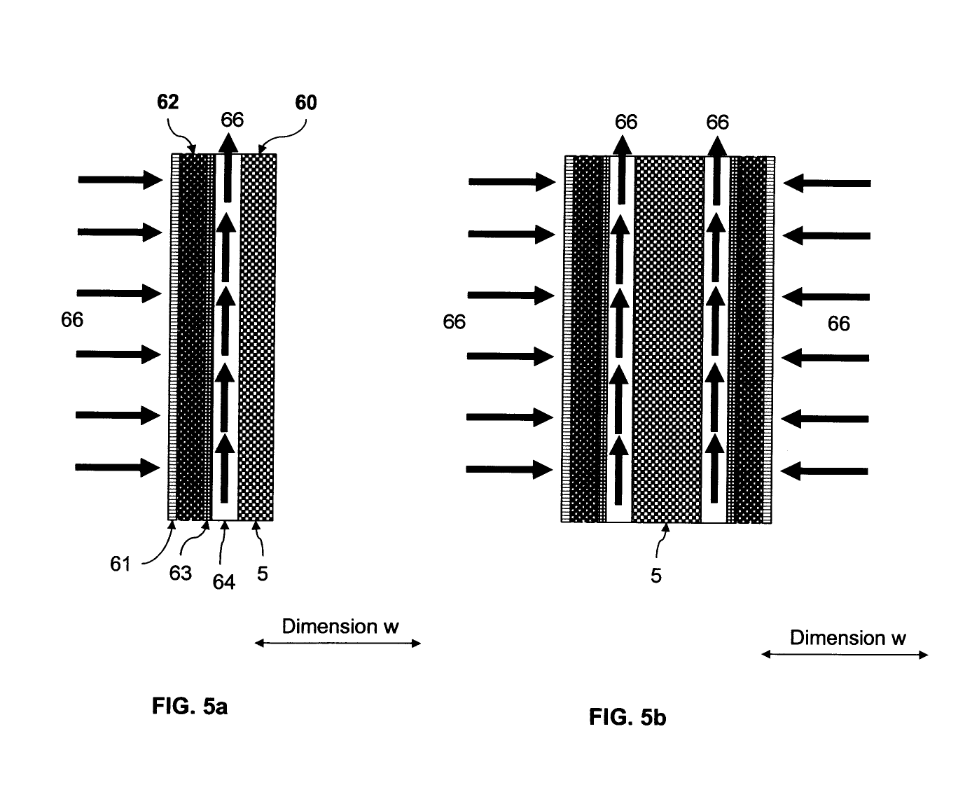

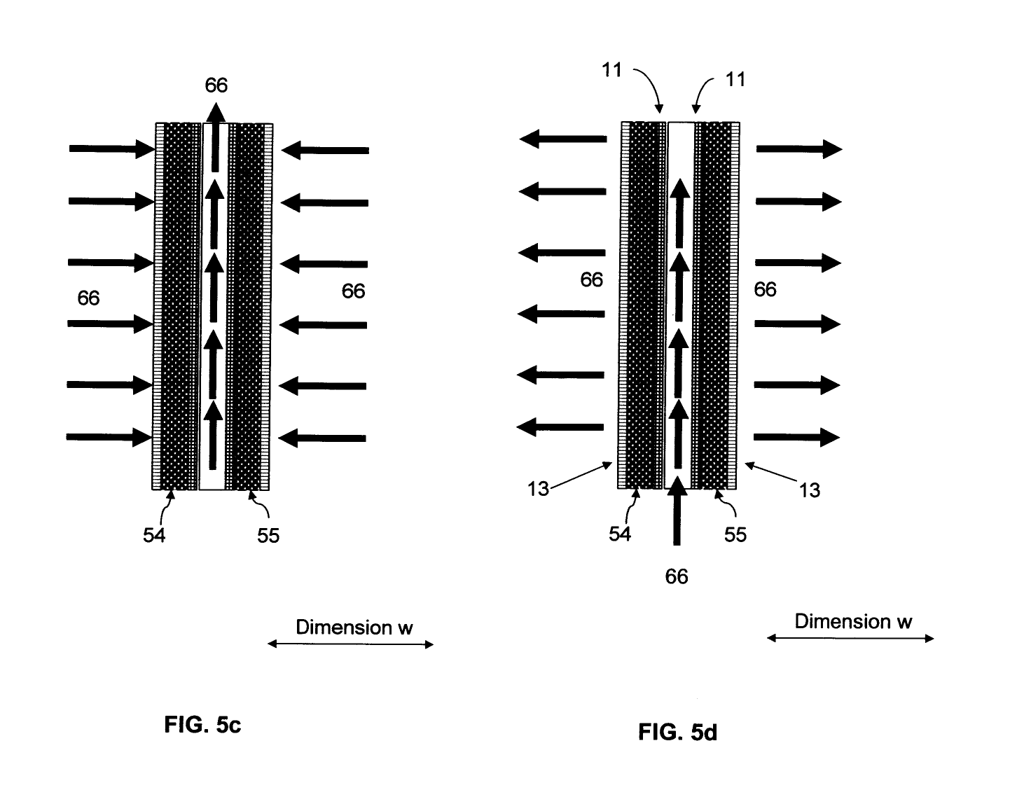

FIG. 5(a) is a schematic representation of electrolyte flow through electrochemical cell geometry 60. As shown, the electrolyte flow 66 is directed by the input flow plate 61 perpendicular to the long axis of fuel compartment 62, that is, in a direction essentially parallel to dimension w of the fuel compartment through screen 63 into output flow channel 64 and eventually out of the cell. As a result, the electrolyte compartment flow is across the shortest dimension of the fuel compartment. Also, the electrolyte directs the reaction products across the fuel compartment and eventually out of the cell. This pathway provides a path of least resistance and minimizes the accumulation of reaction product in the cell.

The movement or flow of the electrolyte can also induce mechanical motion or vibration of the fuel particles, which causes the reaction products to dislodge from the fuel particles, thus maintaining an active surface of the fuel particle. As the electrolyte passes through the electrochemical compartment fuel particles and reaction products are directed toward screen 63 and eventually into the output flow channel 64. The electrolyte then flows up (shown) or otherwise along an axis of the output flow channel and exits the cell. The removal of the reaction products in this manner provides a relatively high concentration of electrochemical fuel that is chemically active.

FIG. 5(b) is a schematic representation of electrolyte flow 66 through electrochemical cell geometry with a centrally arranged electrode 5. This electrochemical cell geometry provides for the flow of electrolyte to both sides of the electrode. As a result, this arrangement provides near equal pressure on both sides of the central electrode. In such a design, the centrally arranged electrode is essentially self supporting thus requiring less structural support than the arrangement depicted in FIG. 5(a).

FIG. 5(c) is a schematic representation of electrolyte flow through electrochemical cell geometry with opposing metal electrodes 54 and 55. This electrochemical cell geometry provides for the flow of electrolyte to both sides of the electrodes 54 and 55. As a result, this arrangement provides for the flow of waste out of the cell through a common central chamber. This embodiment mixes the electrochemical waste streams of the metal electrodes 54 and 55.

FIG. 5(d) is a schematic representation of electrolyte flow through electrochemical cell geometry with opposing metal electrodes 54 and 55. This electrochemical cell geometry provides for the flow of electrolyte into the center chamber between the electrodes 54 and 55. As a result, this arrangement provides for the flow of waste out of the cell through individual flow paths. This embodiment prevents the mixing of the electrochemical waste streams of the metal electrodes 54 and 55. Two flow plates 11 separated by flow standoffs 56 (not shown) provide from the entrance of the flowing electrolyte from any side of the cell. Screens 13 then make up and define the outer electrochemical fuel cavity and the waste exit flow space.

The flow of electrolyte through the electrochemical cell can be controlled in any number of ways such as in a continuous or semi-continuous mode. For example, a continuous process can include a constant flow of electrolyte during the discharge cycle of the cell. Alternatively, the amount of electrolyte through the cell can vary with time during the discharge cycle of the cell.

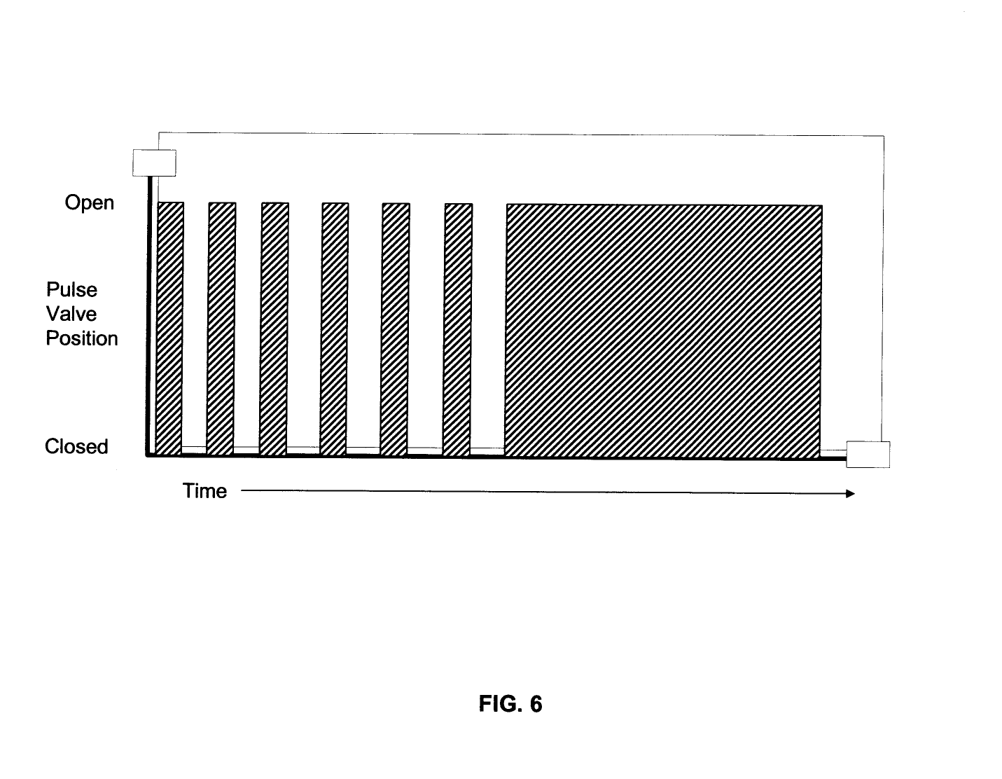

In one embodiment, FIG. 6 represents the opening and closing of a pulse valve with respect to time during the discharge cycle of the cell. The pulse valve is used in-part to control the flow of electrolyte from the electrolyte source to the electrochemical cell. As shown, the pulse valve provides a stuttering effect to the electrolyte flow, followed by a continuous flow of electrolyte. This complete cycle is then repeated any number of times during a given discharge of any one selected cell compartment in an electrochemical battery. The pulse valve is open and closed to produce a pressure differential and flow pulse (a shuddering effect) thereby causing vibrations that facilitate the release of the electrochemical reaction products from the solid fuel in the cell. The pulses are followed by a steady flow of electrolyte to carry the released reaction products out of the cell. This cyclic process can be repeated for other adjoining cells in a battery as needed. The pulse process is applied to a given cell at intervals chosen to optimize the removal of the reaction products from the cell.

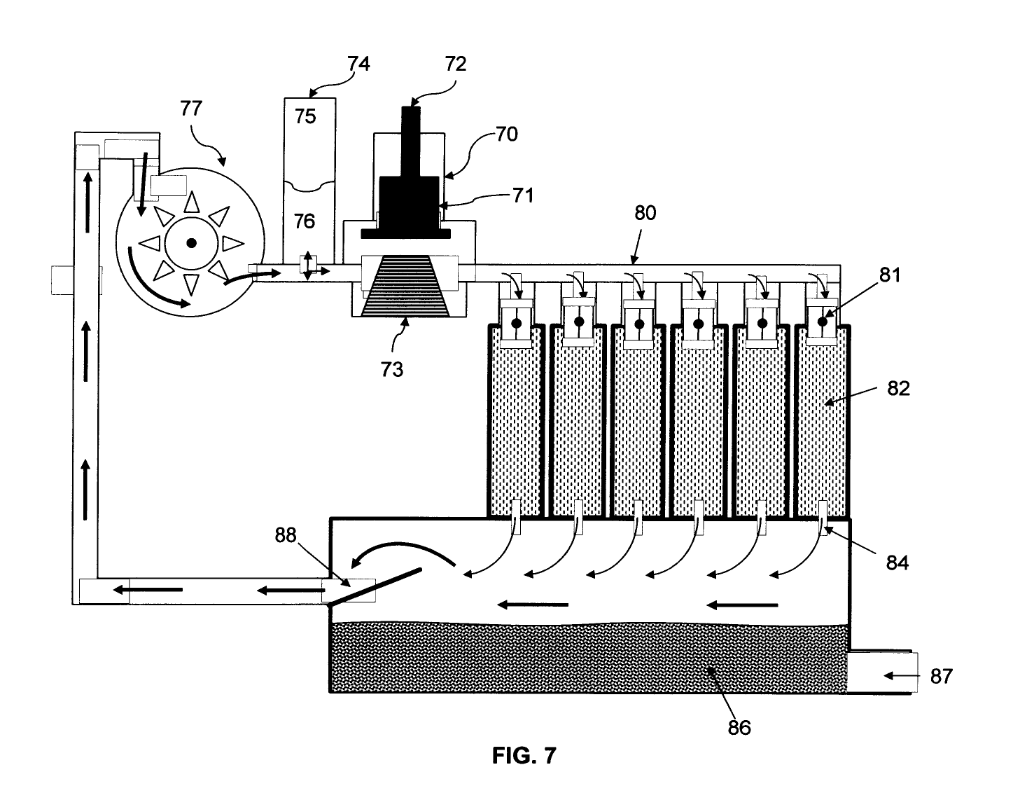

FIG. 7 is a schematic representation of the electrolyte flow through a parallel arrangement of cells in an electrochemical battery. A pulse valve 70 is comprised of a plunger 72, pulse valve gate 71, and pulse valve seat 73. As shown, the pulse valve 70 is in the open position. However, with the controlled downward movement of plunger 72, the pulse valve will close as the pulse valve gate 71 comes in contact with pulse valve seat 73. As a result, the flow of electrolyte to the one or more cells is temporarily stopped. Pump 77 provides for flow and pressurization of the electrolyte. When pulse valve 70 is in the closed position, the electrolyte is pressurized by the action of pump 77 into air spring 74. Electrolyte volume 76 is driven into air spring 74 thereby compressing air spring volume 75. When the pulse valve 50 opens, the air spring 75 expands and pushes the electrolyte volume 76 through the pulse valve. The resulting pressure build-up in conjunction with the action of pump 77, assures the sudden and sustained flow of electrolyte into the cell electrolyte distribution manifold 80. As shown, the electrolyte is forced through open cell valves 81 and into cell volumes 82, dislodging reaction product through cell waste openings 84 into a discharge storage tank. The solid reaction products 86 settle to the bottom of the discharge storage tank and are retained by waste retainer 88. The solid reaction products can be removed periodically, or as needed, through waste port 87. The electrolyte can then be recycled to the electrochemical cells.

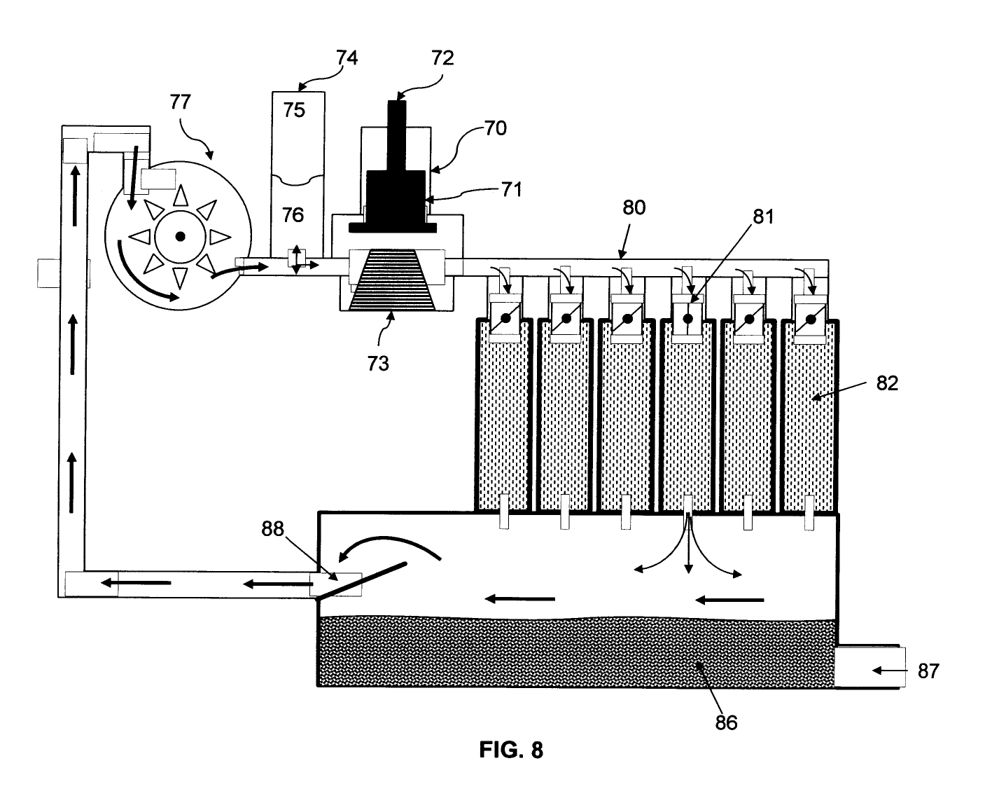

FIG. 8 is a schematic representation of the electrolyte flow similar to the arrangement shown in FIG. 7, with the exception that all of the cell valves 81 are closed except one. In this manner, one cell receives the full force and action of the pump 77, the air spring 74, and the pulse valve 70. Each of the cells can be periodically flushed of reaction products in this manner.

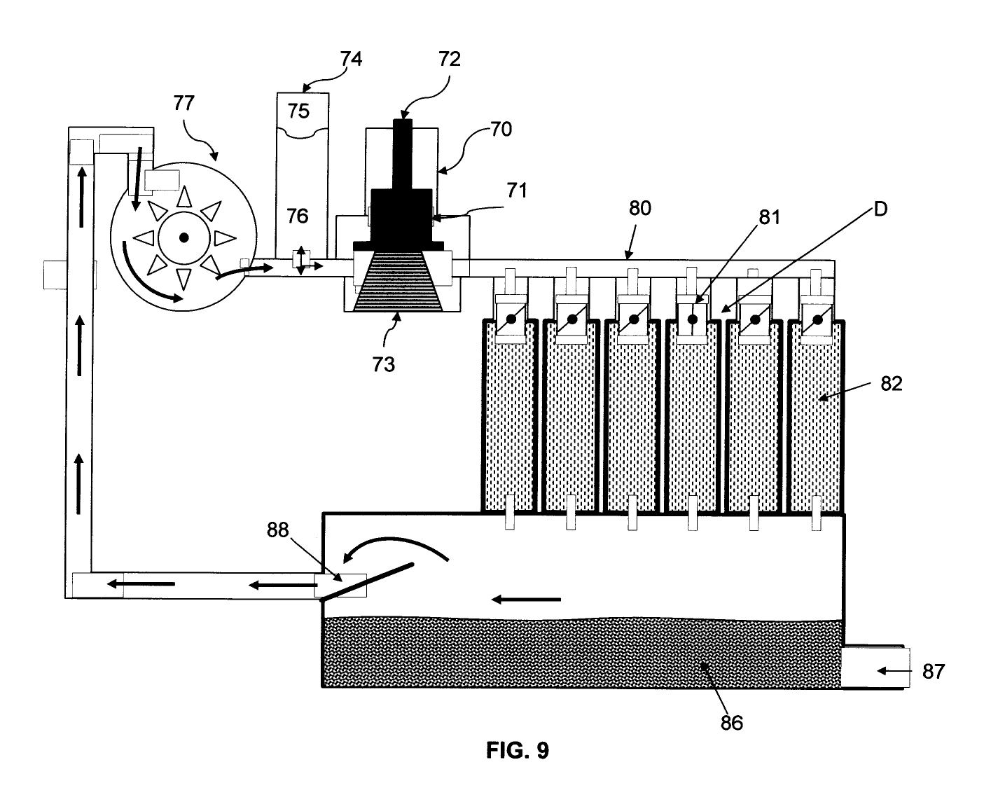

FIG. 9 is a schematic representation of the electrolyte flow similar to the arrangement shown in FIG. 8, with the exception that pulse valve 70 is closed. In this configuration, no electrolyte flows through cell D. The pulse valve is then opened and cell D can receive the full force and action of pump 77, air spring 74, and pulse valve 70. Air spring 74 is fully compressed by the action of pump 77.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

While particular embodiments of the present disclosure are described above, it will be apparent to those skilled in the art that various changes and modifications may be made therein without departing from the spirit or scope of the disclosure. It will be understood, however, that this disclosure is, in many respects, only illustrative. Changes may be made in details, particularly in matters of shape and size without exceeding the scope of the disclosure.

All publications, patents and patent applications cited in this specification are herein incorporated by reference, and for any and all purposes, as if each individual publication, patent or patent application were specifically and individually indicates to be incorporated by reference. In the case of inconsistencies, the present disclosure will prevail.

I claim:

1. An electrochemical cell comprising:
an electrode; and
a fuel compartment with input and output sidewalls of dimension h and end walls of dimension w, wherein the fuel compartment is arranged between an input flow plate and output flow channel, the input flow plate adjacent to the input side wall and the output flow channel adjacent to the output side wall of the fuel compartment,
the input flow plate comprising a porous membrane or a plurality of openings through which electrolyte can flow into the fuel compartment from an electrolyte source, wherein the porous membrane or the openings extend substantially along a surface of the input flow plate adjacent to the input side wall of the fuel compartment, thereby providing for the flow of the electrolyte through the fuel compartment in a direction essentially parallel to dimension w and into the output flow channel.

2. The electrochemical cell of claim 1 further comprising one or more screens that extend substantially between and along the output side wall of the fuel compartment and the output flow channel.

3. The electrochemical cell of claim 2 wherein at least one of the one or more screens is electrically conductive.

4. The electrochemical cell of claim 3 comprising at least two or more screens, wherein the pore size of the screens decrease in the direction toward the output flow channel.

5. The electrochemical cell of claim 1 wherein the input flow plate is electrically conductive.

6. The electrochemical cell of claim 1 wherein the input flow plate comprises the openings and flaps that extend in the direction of the fuel compartment as electrolyte flows through the openings and into the fuel compartment, whereas the flaps essentially block the openings if there is insubstantial flow of electrolyte.

7. The electrochemical cell of claim 1 wherein the input flow plate comprises a screen.

8. The electrochemical cell of claim 1 wherein the output flow channel is partitioned with flow channel members.

9. The electrochemical cell of claim 8 wherein the flow channel members are electrically conductive.

10. The electrochemical cell of claim 1 wherein the flow channel members are configured to facilitate the insertion and removal of the electrode from the electrochemical cell.

11. The electrochemical cell of claim 1 wherein the electrode is cylindrical and centrally arranged in the electrochemical cell and the output flow channel, the fuel compartment and the input flow plate and are cylindrically shaped and arranged in the recited order about the perimeter of the electrode.

12. The electrochemical cell of claim 1 wherein the electrode is centrally arranged in the electrochemical cell and the cell comprises at least two or more of the output flow channels, at least two or more of the fuel compartments and at least two or more of the input flow plates arranged in the recited order about the electrode.

13. The electrochemical cell of claim 11 further comprising one or more screens that extend substantially between and along the output side wall of the fuel compartment and the output flow channel.

14. The electrochemical cell of claim 12 further comprising one or more screens that extend substantially between and along the output side wall of the fuel compartments and the output flow channels.

15. The electrochemical cell of claim 1 wherein the electrode is an air cathode.

16. The electrochemical cell of claim 1 wherein the electrode is a metal electrochemical cathode.

17. The electrochemical cell of claim 16 comprising two or more electrodes, wherein the electrodes are opposing metal electrochemical cells.

18. An electrochemical cell comprising:
a centrally arranged electrode; and
at least two fuel compartments with output and input sidewalls of dimension h and end walls of dimension w, wherein each of the fuel compartments are arranged between an input flow plate and output flow channel, the input flow plate adjacent to the input side wall and the output flow channel adjacent to the output side wall of the fuel compartment, wherein the at least two fuel compartments are symmetrically arranged on either side of the electrode,
the input flow plates comprising a porous membrane or a plurality of openings through which electrolyte can flow into the fuel compartments from an electrolyte source, wherein the porous membrane or the openings extend substantially along a surface of the input flow plates adjacent to the input side wall of the fuel compartments, thereby providing for the flow of the electrolyte through the fuel compartments in a direction essentially parallel to dimension w and into the output flow channels proximate to the electrode.

19. The electrochemical cell of claim 18 further comprising one or more screens that extend substantially between and along the output side wall of the fuel compartments and the output flow channels.

20. The electrochemical cell of claim 18 wherein the screens are conductive.

21. The electrochemical cell of claim 18 comprising at least two or more screens, wherein the pore size of the screens decrease in the direction toward the output flow channels.

22. The electrochemical cell of claim 18 wherein the input flow plates are electrically conductive.

23. The electrochemical cell of claim 18 wherein the output flow channels are partitioned with electrically conductive flow channel members.

24. The electrochemical cell of claim 18 wherein the electrode is an air cathode.

25. The electrochemical cell of claim 18 wherein the electrode is a metal electrochemical cathode.

26. A method of producing of an electric current comprising:
providing a flow-through electrochemical cell with an electrode and a fuel compartment with input and output sidewalls, wherein the fuel compartment is arranged between an input flow plate and output flow channel, the input flow plate adjacent to the input side wall and the output flow channel adjacent to the output side wall of the fuel compartment, and the input flow plate includes a porous membrane or a plurality of openings through which electrolyte can flow into the fuel compartment from an electrolyte source;
providing a pulse valve to control the flow of electrolyte from an electrolyte source to the electrochemical cell, wherein the pulse valve provides an electrolyte flow cycle comprising staggered electrolyte flow over a pulse time period and a steady flow of electrolyte over a steady time period; and
repeating a plurality of the electrolyte flow cycles.

27. The method of claim 26 wherein the electric current is produced from electrochemical fuel produced utilizing electric current derived from an electric power grid, and the electric current produced is returned to the electric power grid.

28. The method of claim 26 wherein the electric current is produced from electrochemical fuel produced utilizing electric current derived from a renewable energy source, and the electric current produced is sent to the electric power grid.

29. The method of claim 26 wherein the electric current is produced from stored electrochemical fuel and the electric current produced is used as a stand alone electric generation unit.
